(19) United States
(12) Patent Application Publication
(10) Pub. No.: US 2026/0261660 A1
(43) Pub. Date: Sep. 3, 2026

(54) TEMPLATE-BASED INTRA MODE DERIVATION FROM CLOSE DECODED REFERENCE SAMPLES

(71) Applicant: InterDigital CE Patent Holdings, SAS, Paris (FR)

(72) Inventors: Thierry DUMAS, RENNES (FR); Gagan Bihari RATH, RENNES (FR); João Miguel PEREIRA DA SILVA SANTOS, RENNES (FR); Mikael LE PENDU, RENNES (FR)

(21) Appl. No.: 19/474,581

(22) PCT Filed: Apr. 8, 2024
(86) PCT No.: PCT/EP2024/059519

§ 371 Date: Oct. 10, 2025

(30) Foreign Application Priority Data
Apr. 12, 2023 (EP) 23305549.0

(51) Int. Cl. H04N 19/11; H04N 19/105; H04N 19/176; H04N 19/70

(52) U.S. Cl. CPC H04N 19/11; H04N 19/105; H04N 19/176; H04N 19/70

(57) ABSTRACT

A method and an apparatus for encoding or decoding a video are provided. At least one derived intra prediction mode is obtained for a video block using a template-based intra prediction mode derivation. The template-based intra prediction mode derivation comprises predicting a template of the video block based on a first intra prediction mode that uses reference samples of the template. The template of the video block comprises a top part located above the video block and a left part located on the left of the video block. Predicting the top part of the template based on the first intra prediction mode uses a first set of reference samples and predicting the left part of the template based on the first intra prediction mode uses a second set of reference samples, the first set of reference samples and the second set of reference samples being different. A block predictor is obtained for the video block based on the at least one derived intra prediction mode and the video block is decoded based on the block predictor.

This application claims the priority to European Application No. 23305549.0, filed on 12 Apr. 2023, which is incorporated herein by reference in its entirety.

### TECHNICAL FIELD

The present embodiments generally relate to video compression. The present embodiments relate to a method and an apparatus for encoding or decoding an image or a video. More particularly, the present embodiments relate to improving template-based intra prediction.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. In inter prediction, motion vectors used in motion compensation are often predicted from motion vector predictor. To reconstruct the video, the compressed data are decoded by inverse processes corresponding to the entropy coding, quantization, transform, and prediction.

### SUMMARY

According to an aspect, a method for decoding a video is provided. The method comprises obtaining at least one derived intra prediction mode for a video block using a template-based intra prediction mode derivation, wherein the template-based intra prediction mode derivation comprises predicting a template of the video block based on a first intra prediction mode that uses reference samples of the template, wherein the template of the video block comprises a top part located above the video block and a left part located on the left of the video block, and wherein predicting the top part of the template based on the first intra prediction mode uses a first set of reference samples and predicting the left part of the template based on the first intra prediction mode uses a second set of reference samples, the first set of reference samples and the second set of reference samples being different, obtaining a block predictor for the video block based on the at least one derived intra prediction mode, decoding the video block based on the block predictor.

According to another aspect, an apparatus for decoding a video is provided. The apparatus comprises one or more processors operable to obtain at least one derived intra prediction mode for a video block using a template-based intra prediction mode derivation, wherein the template-based intra prediction mode derivation comprises predicting a template of the video block based on a first intra prediction mode that uses reference samples of the template, wherein the template of the video block comprises a top part located above the video block and a left part located on the left of the video block, and wherein predicting the top part of the template based on the first intra prediction mode uses a first set of reference samples and predicting the left part of the template based on the first intra prediction mode uses a second set of reference samples, the first set of reference samples and the second set of reference samples being different, obtain a block predictor for the video block based on the at least one derived intra prediction mode, decode the video block based on the block predictor.

According to an aspect, a method for encoding a video is provided. The method comprises obtaining at least one derived intra prediction mode for a video block using a template-based intra prediction mode derivation, wherein the template-based intra prediction mode derivation comprises predicting a template of the video block based on a first intra prediction mode that uses reference samples of the template, wherein the template of the video block comprises a top part located above the video block and a left part located on the left of the video block, and wherein predicting the top part of the template based on the first intra prediction mode uses a first set of reference samples and predicting the left part of the template based on the first intra prediction mode uses a second set of reference samples, the first set of reference samples and the second set of reference samples being different, obtaining a block predictor for the video block based on the at least one derived intra prediction mode, encoding the video block based on the block predictor.

According to another aspect, an apparatus for encoding a video is provided. The apparatus comprises one or more processors operable to obtain at least one derived intra prediction mode for a video block using a template-based intra prediction mode derivation, wherein the template-based intra prediction mode derivation comprises predicting a template of the video block based on a first intra prediction mode that uses reference samples of the template, wherein the template of the video block comprises a top part located above the video block and a left part located on the left of the video block, and wherein predicting the top part of the template based on the first intra prediction mode uses a first set of reference samples and predicting the left part of the template based on the first intra prediction mode uses a second set of reference samples, the first set of reference samples and the second set of reference samples being different, obtain a block predictor for the video block based on the at least one derived intra prediction mode, encode the video block based on the block predictor.

Further embodiments that can be used alone or in combination are described herein.

One or more embodiments also provide a computer program comprising instructions which when executed by one or more processors cause the one or more processors to perform the method for encoding/decoding a video according to any of the embodiments described herein. One or more of the present embodiments also provide a non-transitory computer readable medium and/or a computer readable storage medium having stored thereon instructions for encoding/decoding a video according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder within which aspects of the present embodiments may be implemented.

FIG. 3 illustrates a block diagram of an embodiment of a video decoder within which aspects of the present embodiments may be implemented.

FIGS. 4A and 4B illustrate examples of angular intra prediction modes in VVC.

FIGS. 5A and 5B illustrate a relationship between the extent of the set of decoded reference samples surrounding a W×H block to be predicted and a range of allowed intra prediction angles.

FIG. 6 illustrates an example of angular modes replaced by wide-angular modes for a non-square block whose width is strictly larger than its height, in VVC and ECM.

FIG. 7A illustrates an example of a template of a block to encode or decoded and decoded reference samples for the template.

FIG. 7B illustrates an example of a range of allowed directional intra prediction modes for a block having a size of width×height during the TIMD derivation step in the case of TIMD with wide-angle intra prediction modes.

FIG. 8 illustrates an example of an adaptation of the set of reference samples of a template for a block to be predicted using a template-based intra prediction mode derivation according to an embodiment.

FIG. 9 illustrates another example of an adaptation of the set of reference samples of a template for a block to be predicted using a template-based intra prediction mode derivation according to an embodiment.

FIG. 10 illustrates an example of an adaptation of the set of reference samples of a template for a block to be predicted using a template-based intra prediction mode derivation according to an embodiment, when left part of the template is not available.

FIG. 11 illustrates an example of an adaptation of the set of reference samples of a template for a block to be predicted using a template-based intra prediction mode derivation according to an embodiment, when top part of the template is not available.

FIG. 12 illustrates an example of an adaptation of the set of reference samples of a template for a block to be predicted using a template-based intra prediction mode derivation according to another embodiment.

FIG. 13 illustrates an example of an adaptation of the set of reference samples of a template for a block to be predicted using a template-based intra prediction mode derivation according to another embodiment.

FIG. 14 illustrates an example of an adaptation of the set of reference samples of a template for a block to be predicted using a template-based intra prediction mode derivation according to another embodiment.

FIG. 15 illustrates an example of an adaptation of the set of reference samples of a template for a block to be predicted using a template-based intra prediction mode derivation according to another embodiment.

FIG. 16 illustrates an example of an adaptation of the set of reference samples of a template for a block to be predicted using a template-based intra prediction mode derivation according to another embodiment.

FIG. 17 illustrates an example of a method for encoding a video block according to an embodiment.

FIG. 18 illustrates an example of a method for decoding a video block according to an embodiment.

FIG. 19 illustrates an example of a method for template-based intra mode prediction derivation for encoding or decoding a video block according to an embodiment.

FIG. 20 illustrates an example of a method for template-based intra mode prediction derivation for encoding or decoding a video block according to another embodiment.

FIG. 21 illustrates a block diagram of a system within which aspects of the present embodiments may be implemented, according to another embodiment.

FIG. 22 shows two remote devices communicating over a communication network in accordance with an example of the present principles.

FIG. 23 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

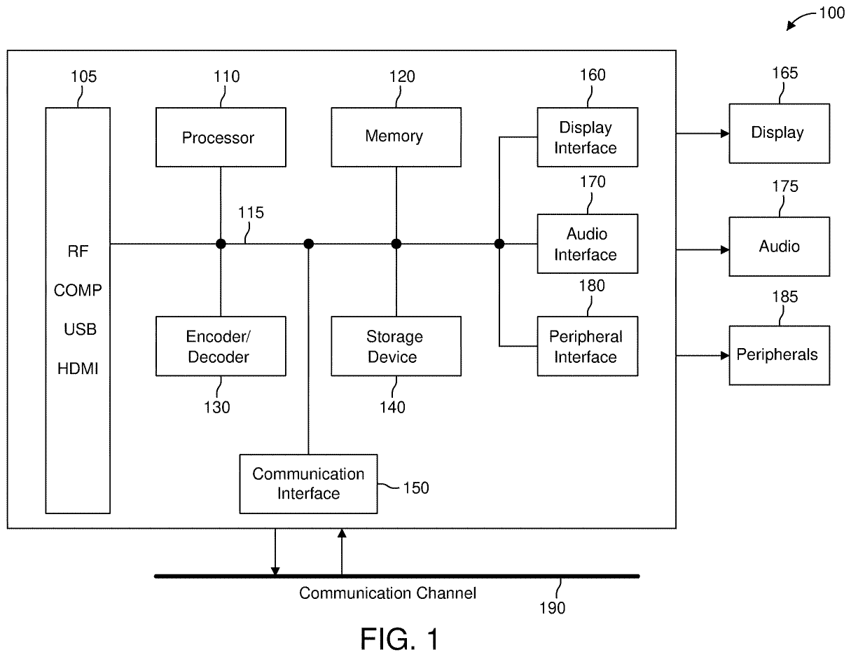

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions.

As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, standard developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

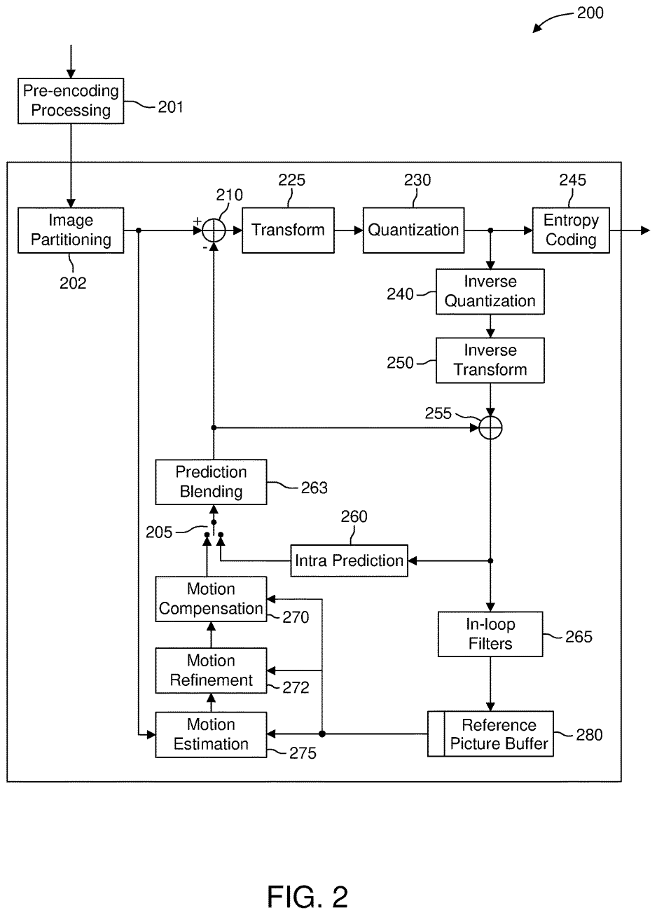

FIG. 2 illustrates a video encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or a VVC standard or an encoder employing technologies similar to HEVC or VVC, such as an encoder ECM under development by JVET (Joint Video Exploration Team).

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs (Coding units) or blocks. In the disclosure, different expressions may be used to refer to such a unit or block resulting from a partitioning of the picture. Such wording may be coding unit or CU, coding block or CB, luminance CB, block or video block. A CTU (Coding Tree Unit) may refer to a group of blocks or group of units. In some embodiments, a CTU may be considered as a block, or a unit as itself.

Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

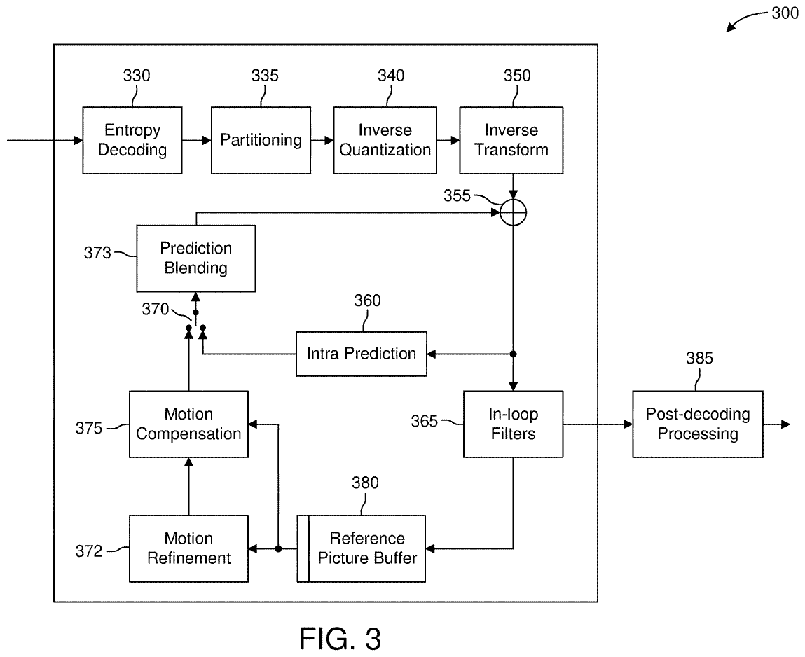

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

Embodiments described herein relates to intra prediction, and more particularly to template-based intra mode derivation (TIMD).

Any one of the embodiments described herein can be implemented for instance in an intra prediction module 260 of the video encoder 200 or an intra prediction module 360 of the video decoder 300.

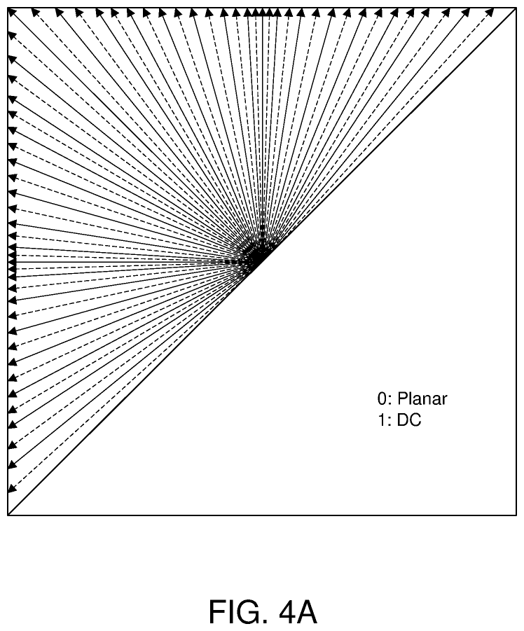

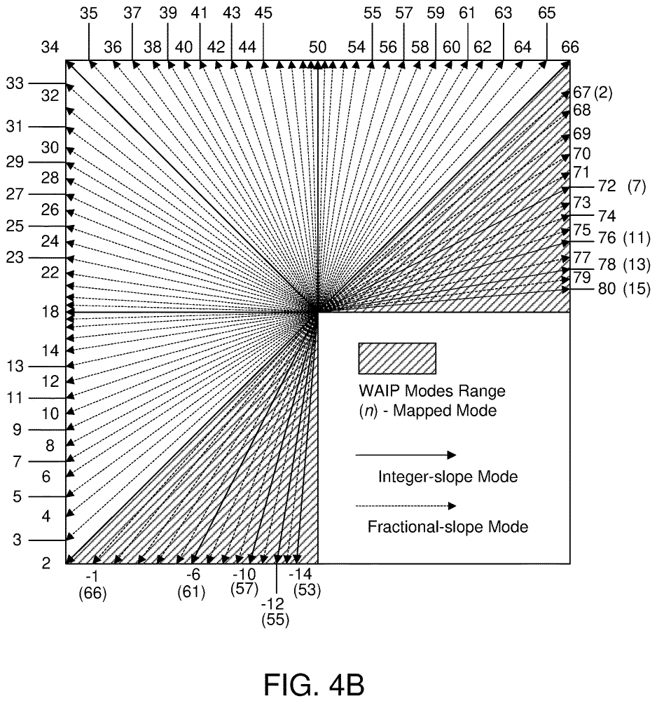

To capture the arbitrary edge directions presented in natural video, the number of directional intra prediction modes in VVC is extended from 33, as used in HEVC, to 65. The new directional modes not in HEVC are depicted as dotted arrows in FIG. 4A. These denser directional intra prediction modes apply for all block sizes and for both luma and chroma intra predictions. From HEVC to VVC, the planar mode and the DC mode remain unchanged, excluding the following minor modification. In HEVC, every intra-coded block has a square shape and the length of each of its side is a power of 2. Thus, no division operations are required to generate an intra-predictor using DC. In VVC, blocks can have a rectangular shape that necessitates the use of a division operation per block in the general case. To avoid division operations for DC prediction, only the longer side is used to compute the average for non-square blocks.

In ECM, the core structure of the 67 intra prediction modes is inherited from that in VVC. This core structure is refined in ECM as follows. The four-tap interpolation for a directional intra prediction mode from VVC becomes a six-tap interpolation and Position Dependent Intra Prediction Combination (PDPC) is supplemented with gradient PDPC.

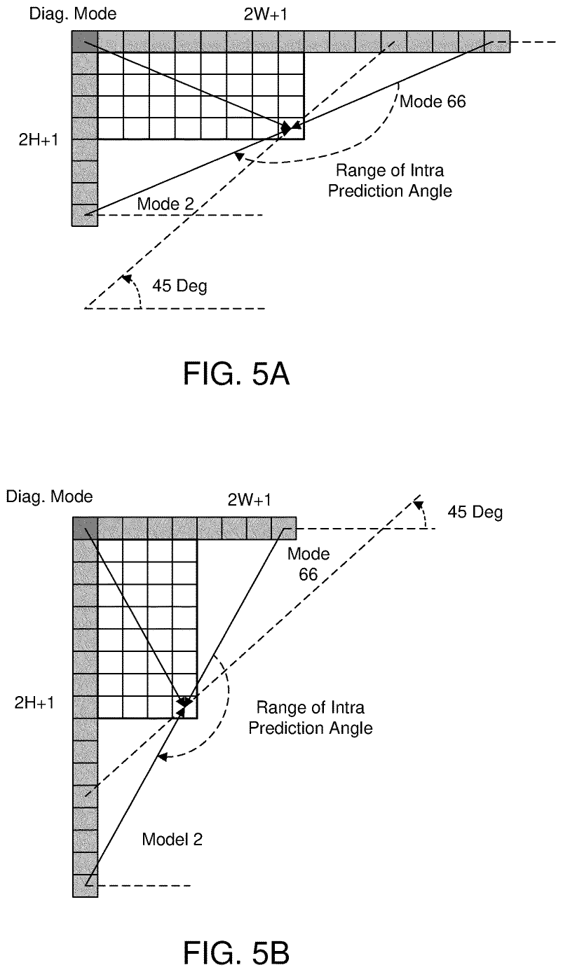

In VVC and ECM, for non-square blocks, several conventional angular intra prediction modes are replaced with wide angular modes. The replaced modes are signaled using the original method and remapped to the indexes of wide angular modes after parsing. The total number of core intra prediction modes is unchanged, i.e., 67. Angular modes and wide-angular modes in VVC are illustrated on FIG. 4B. For the current W×H block to be predicted, FIGS. 5A and 5B illustrate the set of decoded reference samples, made of an array of top decoded reference samples of length 2W+1 and an array of left decoded reference samples of length 2H+1. FIGS. 5A and 5B also show the relationship between the extent of the decoded reference samples around the current W×H block and the range of allowed intra prediction angles. The number of replaced modes in wide-angular direction mode depends on the aspect ratio of the block. The table 1 below presents an example of the indices of the intra prediction modes replaced by wide-angular modes in VVC and ECM, depending on the size W×H of the current block to be predicted. Such a replacement of intra prediction modes by wide-angular modes is also called in the following the wide-angle conversion rule.

TABLE 1
indices of the intra prediction modes replaced by wide-angular
modes in VVC and ECM (67 core intra prediction modes).

| Aspect ratio | replaced intra prediction modes indices |
|---|---|
| W/H == 2 | 2, 3, 4, 5, 6, 7, |
| W/H == 4 | 2, 3, 4, 5, 6, 7, 8, 9, 10, 11 |
| W/H == 8 | 2, 3, 4, 5, 6, 7, 8, 9, 10, 11, 12, 13 |
| W/H == 16 | 2, 3, 4, 5, 6, 7, 8, 9, 10, 11, 12, 13, 14, 15 |
| W/H == 32 | 2, 3, 4, 5, 6, 7, 8, 9, 10, 11, 12, 13, 14, 15, 16 |
| W/H == 1 | none |
| H/W == 2 | 61, 62, 63, 64, 65, 66 |
| H/W == 4 | 57, 58, 59, 60, 61, 62, 63, 64, 65, 66 |
| H/W == 8 | 55, 56, 57, 58, 59, 60, 61, 62, 63, 64, 65, 66 |
| H/W == 16 | 53, 54, 55, 56, 57, 58, 59, 60, 61, 62, 63, 64, 65, 66 |
| H/W == 32 | 52, 53, 54, 55, 56, 57, 58, 59, 60, 61, 62, 63, 64, 65, |
| | 66 |

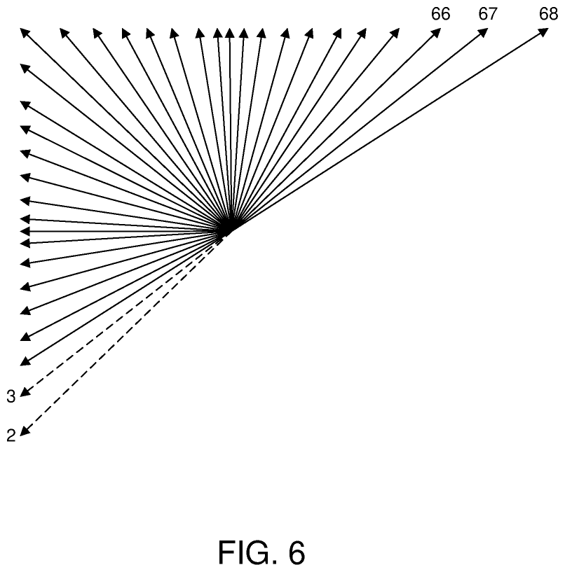

FIG. 6 shows an example of how angular intra modes are replaced by wide angular modes for a non-square block whose width is strictly larger than its height. In this example, mode 2 is replaced by wide angle mode 67. Mode 3 is replaced by wide angle mode 68. For instance, if the current block to be predicted is 8×4, this process of substitution will go on incrementally until mode 7 is replaced by wide angle mode 72.

For example, in ECM, for converting an intra-prediction mode index into its corresponding wide-angle mode, the following can be applied. In the case of prediction of a W×H block, non-TIMD, i.e. using one of the 65 directional intra prediction modes, i denotes the index of the current intra prediction mode, wide denotes the index of the current intra prediction mode according to the wide-angle conversion, let's denote DC_IDX=1, VDIA_IDX=66, i_{wide} can be obtained by the following pseudo-code:

if (i > DC_IDX)
{
modeShift[] = {0, 6, 10, 12, 14, 15};
deltaSize = | log2(W) - log2(H) |;
if (W > H && i < 2 + modeShift[deltaSize])
{
i_{wide} = i + (VDIA_IDX - 1);
}
else if (H > W && i > VDIA_IDX - modeShift[deltaSize])
{
i_{wide} = I - (VDIA_IDX - 1);
}
else
{
i_{wide} = I
}
}

It is to be noted that no wide-angle conversion is done for the indices of PLANAR and D, and no wide-angle conversion is done if H equals W (the current block is square).

A current block to encode/decode can be predicted using template-based intra mode derivation (TIMD). TIMD relies on the assumption that, for a given block, a given intra prediction mode predicting an area of pixels surrounding this block, a.k.a template of this block, with high quality is very likely to predict this block with high quality. Using this assumption and the same area of available decoded pixels surrounding this block at both the encoder and decoder sides, a search for the intra prediction modes that predict the template with the highest qualities, i.e. most likely predict this block with the highest qualities, can be constructed, this search being identical at both the encoder and decoder sides. Thanks to this principle, instead of signaling intra prediction mode index (ices), the entire prediction of a given block via TIMD can be signaled from the encoder to the decoder via a single flag specifying whether TIMD is used or not. This results in sizable savings of bits in intra prediction signaling. Below, all the explanations apply the same way at both the encoder and decoder sides.

In TIMD in ECM, for example ECM-7.0, for a current block to be encoded/decoded, TIMD follows a two-step process as described in Yang Wang, Li Zhang, Kai Zhang, Zhipin Deng, Na Zhang. EE2-related: template-based intra mode derivation using MPMs. Contribution JVET-V0098 at the 22nd JVET meeting in teleconference, from 20 to 28 Apr. 2021. First, a derivation step involving the template of decoded pixels of the block returns the indices of the two intra prediction modes that predict the template with the highest qualities, thus most likely predicting the current block with the highest qualities according to the TIMD assumption. Then, the current block is predicted using the two intra predictions whose indices are provided by the previous derivation step.

The derivation step processes as follows.

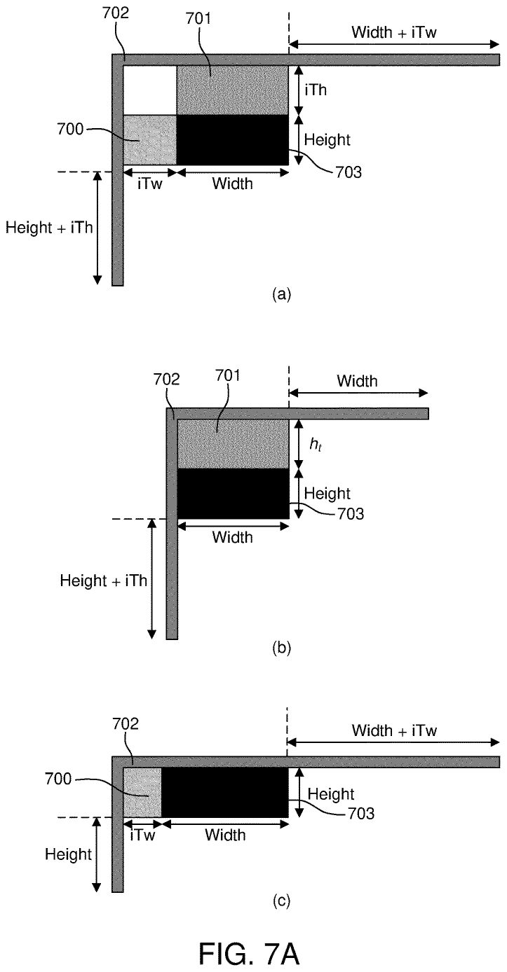

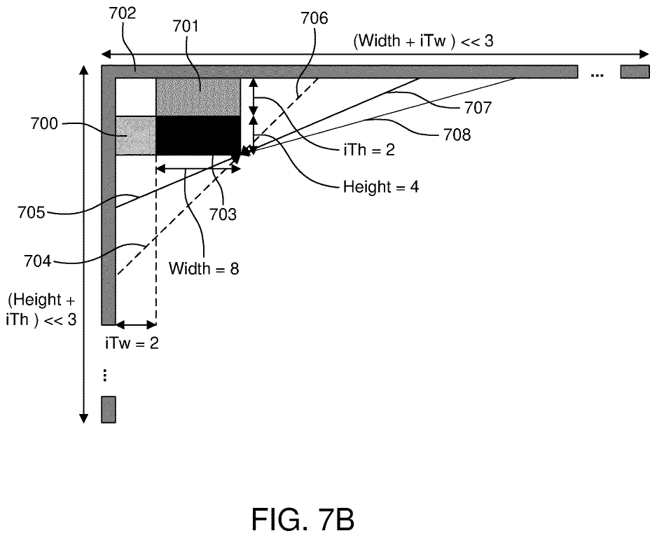

In TIMD in ECM, for the current block the derivation step begins with the extraction of the template of this block and the set of decoded reference sample of the template. For instance, in FIG. 7A (a), the iTw×height left portion (700) and the width×iTh above portion (701) of the template of the current width×height block (703) are extracted from the current decoded luma channel. Besides, the set (702) of 2 (iTw+width)+2 (iTh+height)+1 decoded reference samples of the template are extracted from the current decoded luma channel. In ECM-7.0, the size of the template is defined as follows:

iTw=2 if width≤8, otherwise, iTw=4.

iTh=2 if height≤8, otherwise, iTh=4.

Then, the list L of the indices of the intra prediction modes to be tested on the template is created. For instance, L corresponds to the list of Most Probable Modes (MPMs) of the current block, supplemented with the DC mode DC_IDX, horizontal mode HOR_IDX, and vertical mode VER_IDX if these indices do not already exist in the list of MPMs.

Note that, for TIMD, the set of directional intra prediction modes is extended from 65 to 129, by inserting a direction between each plain black arrow and its neighboring dashed arrow in FIG. 4A. This means that the set of possible intra prediction modes derived via TIMD gathers 131 modes.

As the number of directional intra prediction modes spanning the directions from “bottom-left to top-right” to “top-right to bottom-left” is twice larger for TIMD than the corresponding number of directional modes in VVC, meaning that a directional intra prediction mode index in TIMD belongs to [2, 130], the index of each directional intra prediction mode in L is re-mapped. If i denotes the index of a directional intra prediction mode in L, its re-mapping can be expressed as i=(i<<1)−2. The table 1 above indicating the directional intra prediction modes that are replaced by wide-angle directional intra prediction modes based on the block's aspect ratio is thus adapted to this remapping. The wide-angle conversion rule is based on the aspect ratio of the block but table 1 becomes table 2 below. For instance, for a given 8×4 block using TIMD, mode 2 is replaced by wide angle mode 131, mode 3 is replaced by wide angle mode 132, mode 4 is replaced by wide angle mode 133, . . . , mode 12 is replaced by wide angle mode 141.

TABLE 2

| indices of the intra prediction modes replaced by wide-angular | |
|---|---|
| modes in TIMD in ECM. | |
| | replaced intra prediction modes |
| condition | indices |
| W/H == 2 | [\|2, 12\|] |
| W/H == 4 | [\|2, 20\|] |
| W/H == 8 | [\|2, 24\|] |
| W/H == 16 | [\|2, 28\|] |
| W/H == 32 | [\|2, 30\|] |
| W/H == 1 | none |
| H/W == 2 | [\|120, 130\|] |
| H/W == 4 | [\|112, 130\|] |
| H/W == 8 | [\|108, 130\|] |
| H/W == 16 | [\|104, 130\|] |
| H/W == 32 | [\|102, 130\|] |

For example, for converting an intra-prediction mode index into its corresponding wide-angle mode, the following can be applied when using TIMD. In the case of prediction of a current W×H block, TIMD, i.e. using one of the 129 directional intra prediction modes, i denotes the index of the current intra prediction mode, i_{wide} denotes the index of the current intra prediction mode according to the wide-angle conversion, let's denote EXT_VDIA_IDX=130, i_{wide} can be obtained by the following pseudo-code:

if (i > DC_IDX)
{
modeShift[] = {0, 11, 19, 23, 27, 29};
deltaSize = | log2(W) - log2(H) |;
if (W > H && i < 2 + modeShift[deltaSize])
{
i_{wide} = I + (EXT_VDIA_IDX - 1);
}
else if (H > W && i > EXT_VDIA_IDX - modeShift[deltaSize])
{
i_{wide} = I - (EXT_VDIA_IDX - 1);
}
else
{
i_{wide} = i
}
}

Then, in a so-called “first pass”, for each intra prediction mode of index in L, a prediction of the template (700 and 701) is obtained for this mode from the reference samples (702), and the SATD between this prediction and the template is calculated. The two intra prediction modes i₀, i₁ yielding the two smallest prediction SATDs are retained.

Then, in a so-called “second pass”, for each of the two intra prediction modes i₀, i₁ retained by the “first pass”, if this mode is neither PLANAR nor DC, TIMD also tests on the template of the current block in terms of prediction SATD its two closest directional intra prediction modes. Depending on these additional tests, the indices i₀, i₁ of the two intra prediction modes yielding the two smallest prediction SATDs can be updated.

Finally, a blending condition is defined, and two blending weights are potentially determined. Let timdIsBlend denote the flag indicating whether the TIMD blending applies. Let satd₀ and satd₁ be the first smallest and second smallest prediction SATDs respectively associated to the retained intra prediction modes i₀, i₁.

$$timdIsBlend = {satd}_{1} < 2 {satd}_{0}$$

In case timdIsBlend is true, the weight w₀ associated to the index i₀ of the intra prediction mode yielding the smallest prediction SATD is equal to

$$64 \frac{{satd}_{1}}{{satd}_{0} + {satd}_{0}} ,$$

this division having an integerized form. As the expression of the integerized form of the division is implementation-dependent (and has already changed from two successive versions of ECM for instance), it is not detailed here. Then, the weight w₁ associated to the index i₁ of the intra prediction mode yielding the second smallest prediction SATD is equal to 64−w₀.

Note that, in the above explanation of the TIMD derivation step, it is assumed that both the left and above portions of the template of the current block are available. In case only the above portion of the template of the current block is available, FIG. 7A (a) becomes FIG. 7A (b). In case only the left portion of the template of the current block is available, FIG. 7A (a) becomes FIG. 7A (c).

The information {i₀, i₁, timdIsBlend, w₀, w₁} is passed on to the prediction step which described below.

The prediction of the block in the TIMD processes as follows.

If timdIsBlend is false, the prediction predFinal of the current block from its set of decoded reference samples is performed by the intra prediction mode of index i₀.

Otherwise, a first prediction predTimd₀ of the block is obtained using the intra prediction mode of index i₀ from the set of decoded reference samples of the block. A second prediction predTimd₁ is obtained for the block using the intra prediction mode of index i₁ from the set of decoded reference samples of the block. The prediction predFinal of the current block results from the blending of the first prediction predTimd₀ and the second prediction predTimd₁,

$$predFinal ( x , y ) = ( {{\sum }_{i = 0}}^{1} \{ {w}_{i} - {PredTimd}_{i} ( x , y ) \} ) ≫ 6$$

with (x, y) being the coordinate of a predicted sample of the block.

The signaling of TIMD for the current block is done as follows.

In ECM-7.0, for the current block, TIMD is signaled via a TIMD flag, placed after the flag of Matrix-based Intra Prediction (MIP) in the decision tree of the signaling of the intra prediction mode selected to predict this block.

From ECM-7.0 to ECM-8.0, TIMD with extended wide-angle intra prediction modes is integrated as described in Kévin Reuzé, Thierry Dumas, Karam Naser, Ya Chen. EE2-1.10: optimizing the use of reference samples. Contribution JVET-AC0094 at the 29th JVET meeting in teleconference, from 11 to 20 January 2023. Before this integration, whatever the size of the current block using TIMD, a directional intra prediction mode is always picked among 129 allowed directional intra prediction modes. As said above, the number 129 arises from the pre-defined density of directional intra prediction modes spanning the directions from “bottom-left to top-right” to “top-right to bottom-left” in TIMD (twice larger than that in VVC) as illustrated in FIG. 4B.

Note that the wide-angle rule does not change the number 129. For instance, if the current block is 8×8, the index of a directional intra prediction mode belongs to [2, 130]. If the current block is 8×4, the index of a directional intra prediction mode belongs to [13, 141]. If the current block is 16×4, the index of a directional mode belongs to [21, 149].

After the extension of wide-angle intra prediction modes by adding more wide-angle intra prediction modes to be evaluated by TIMD, for the same density of directional intra prediction modes spanning the directions from “bottom-left to top-right” to “top-right to bottom-left” (for example illustrated in FIG. 4B), a directional intra prediction to be evaluated in TIMD is picked among a variable number of allowed directional intra prediction modes. This variable number is larger than 129. The additional allowed directional intra prediction modes are taken from the wide-angle directional intra prediction modes that are newly introduced for blocks of sizes close to the size of the current block.

Precisely, for the current width×height block, let arrayShiftsExt={0,11,19,23,27,29} and deltaSize=abs(log₂(width)−log₂(height)). If width≥height, the indices of the arrayShiftsExt[min(deltaSize+2, 5)−deltaSize] wide-angle vertical positive intra prediction modes following the last allowed vertical positive intra prediction mode are added to the range of allowed directional intra prediction modes indices. If height≥width, the indices of the arrayShiftsExt[min(deltaSize+2, 5)−deltaSize] wide-angle horizontal positive intra prediction modes preceding the first allowed horizontal positive intra prediction mode are added to the range of allowed directional intra prediction modes indices.

For instance, FIG. 7B presents the range of allowed directional intra prediction modes for a current 8×4 block (703) during the TIMD derivation step. The dashed arrow (704) represents the direction of the allowed first horizontal positive intra prediction mode before applying the wide-angle rule for 8×4 blocks, i.e. that of index 2. The dashed arrow (706) represents the direction of the allowed last vertical positive intra prediction mode before applying the wide-angle rule, i.e. that of index 130. Thus, before applying the wide-angle rule, the number of allowed directional modes is 129.

On FIG. 7B, the black arrow (705) shows the direction of the allowed first horizontal positive intra prediction mode after applying the wide-angle rule for 8×4 blocks, i.e. that of index 13. The black arrow (707) shows the direction of the allowed last vertical positive intra prediction mode after applying the wide-angle rule, i.e. that of index 141. Therefore, after applying the wide-angle rule, the number of allowed directional modes is still 129.

On FIG. 7B, the gray arrow (708) indicates the direction of the allowed last vertical positive intra prediction mode after applying the extension as described above of the wide-angle intra prediction modes, i.e. that of index 153. Thus, after applying the extension of the wide-angle intra prediction modes described above, the number of allowed directional modes for the block 8×4 is 141.

For the current width×height block, during the TIMD derivation step, between the “first pass” and the “second pass”, for each intra prediction mode whose index belongs to the added range of allowed directional intra prediction mode indices, with a step of 5, this intra prediction mode is tested on the template of the current block. For instance, in the case of FIG. 7B, each intra prediction mode whose index belongs to [131, 153], with a step of 5 used for parsing this range of index, the intra prediction mode is tested on the template gathering (700) and (701). For the current block using TIMD, during its prediction, a derived intra prediction mode belonging to the added range of allowed directional intra prediction modes applies as it is. This means that, for instance, the wide-angle intra prediction mode of index 153 keeps the same characteristics, notably its parameters characterizing its direction, i.e. intraPredAngle and absInvAngle in ECM, during the TIMD derivation step and the actual prediction of the current block.

Position dependent pixel combination (PDPC) in VVC or ECM is a post processing tool in intra prediction. It aims at removing the discontinuities arising from the initial intra prediction for certain prediction modes at the target block boundaries adjacent to the reference samples. It achieves this by using a weighted combination of the initial prediction value and one or more nearby reference samples. Besides the two non-angular modes, that is, the PLANAR mode and the DC mode, it is also enabled in the case of purely horizontal and purely vertical modes and the angular modes in the directions from the bottom-left corner towards top-right corner of the block and vice versa. Depending on the prediction direction, either the normal PDPC or a gradient PDPC, is applied. PDPC is also used as a post-processing in the derivation process of intra prediction modes of the TIMD coding mode described above.

For the TIMD assumption described above to be valid, i.e. to ensure that a given intra prediction mode predicting the template of the current block with high quality translates into this intra prediction mode very probably predicting the current block with high quality, all the pixels involved in the TIMD derivation step must be highly correlated. Thus, in the TIMD derivation step, the block pixels and the template pixels must be highly correlated. Moreover, the template pixels and the set of decoded reference samples of the template must also be strongly correlated. But, as shown in FIG. 7A (a), the template of the current block features a “hole” (shown as the white square in FIG. 7A (a)) between its left portion and its “above” portion. Because of this “hole”, the set of decoded reference samples of the template of the current block and the template pixels are not as strongly correlated as they could be.

In some embodiments, a method and an apparatus are provided encoding or decoding a block using a TIMD process wherein this “hole” is suppressed.

Note that all the aspects of the embodiments described below apply the same way on both the encoder and decoder sides.

According to an aspect of the present disclosure, a method for encoding or decoding a video block is provided wherein a template intra prediction mode derivation (TIMD) is adapted. More particularly, in some embodiments, for a video block using TIMD, during the derivation step of TIMD, instead of defining a set of reference samples of the template, this set being common to the above and left portions of the template, each portion of the template owns a different set of reference samples. This allows to remove the hole between the template and its reference samples. The reference samples used to predict the template are closer to the template and thus prediction is improved. In addition, this adaptation of the set of reference samples allows to keep the same size of the template using in TIMD in ECM, thus the same prediction unit can be re-used. For instance, the two parts of the template can still have a size which is a power of 2.

According to the embodiments provided herein, the hole in the template is eliminated, thus improving template prediction.

As a beneficial side effect of the elimination of this hole, PDPC and gradient PDPC using the TIMD derivation step can also become more effective. As described above, if PDPC is allowed, PDPC enables to remove some discontinuities between the predicted samples and the reference samples around the boundaries of the predicted block (whether the block to predict is the template or the block). Therefore, around the boundaries of the predicted block, the closer to the reference samples the predicted samples are, the better PDPC works.

Embodiments are provided below wherein a template intra prediction mode derivation (TIMD) is adapted so that each part of the template owns its own set of reference samples.

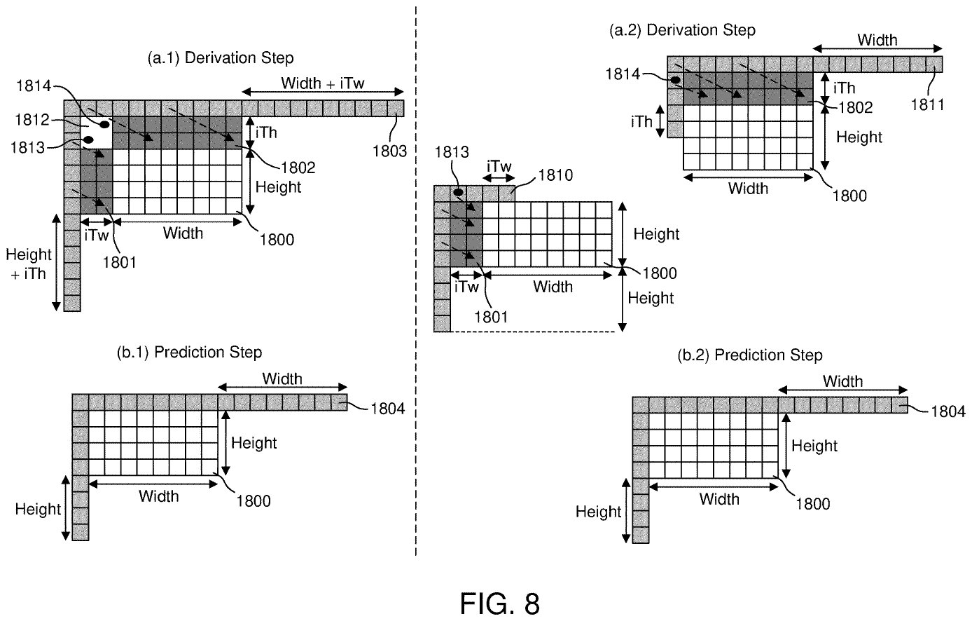

FIGS. 8 (a.1) and (a.2) show a current block to be predicted (1800), its template, and the reference samples of the template during the derivation step of TIMD. FIG. 8 (a.1) illustrates the template (1801 and 1802) and its reference samples (1803) as used in ECM while FIG. 8 (a.2) illustrates an embodiment provided herein of the adaptation of the template (1801 and 1802) and of its reference samples (1810, 1811) for TIMD. In FIGS. 8 (a.1) and (a.2), both the above and left portions of the template of the current block (1800) are available.

In FIG. 8 (a.1), for a given width×height block (1800) during the derivation step of TIMD, for a given intra prediction mode to be tested on the template of (1800), which comprises its iTw×height left portion (1801) and its width×iTh above portion (1802), some reference samples in the set (1803) of 2(width+iTw)+2(height+iTh)+1 reference samples of the template are used to predict both (1801) and (1802). (1812) denotes the iTw×iTh hole between the template and its reference samples that exists in the prediction of the template used in ECM.

In FIG. 8 (a.2), for a given intra prediction mode to be tested on the template of (1800), some reference samples in the set (1810) of reference samples of the left template portion (1801) are used to predict the left template portion (1801) whereas some reference samples in the set (1811) of reference samples of the above template portion (1802) are used to predict the above template portion (1802).

Unlike FIG. 8 (a.1), FIG. 8 (a.2) does not contain any hole between the template of (1800) and its reference samples.

In FIGS. 8 (a.1) and (a.2), to provide an example of which reference samples are used to predict the template of (1800), the black dotted arrows indicate the direction of extrapolation of the reference samples of the template into the template for the directional intra prediction mode of index 48. Expressed differently, for a given sample to be predicted in a template portion, the tail of the arrow crossing this sample locates the reference sample at the center of the directional interpolation filter for computing the prediction of this template sample.

This example reveals that the change of set of reference samples of the template of (1800) from FIG. 8 (a.1) to FIG. 8 (a.2) modifies the template prediction. For instance, in FIG. 8 (a.2), during the prediction of (1801) from (1810), the reference sample (1813) is accessed. But, in FIG. 8 (a.1), (1813) is not involved in the prediction of (1801). Note that a black-filled dot at the end of a marker like (1813) indicates that the marker labels a single pixel instead of a set of pixels with shared color.

Similarly, in FIG. 8 (a.2), during the prediction of (1802) from (1811), the reference sample (1814) is accessed. But, in FIG. 8 (a.1), (1814) is not involved in the prediction of (1802).

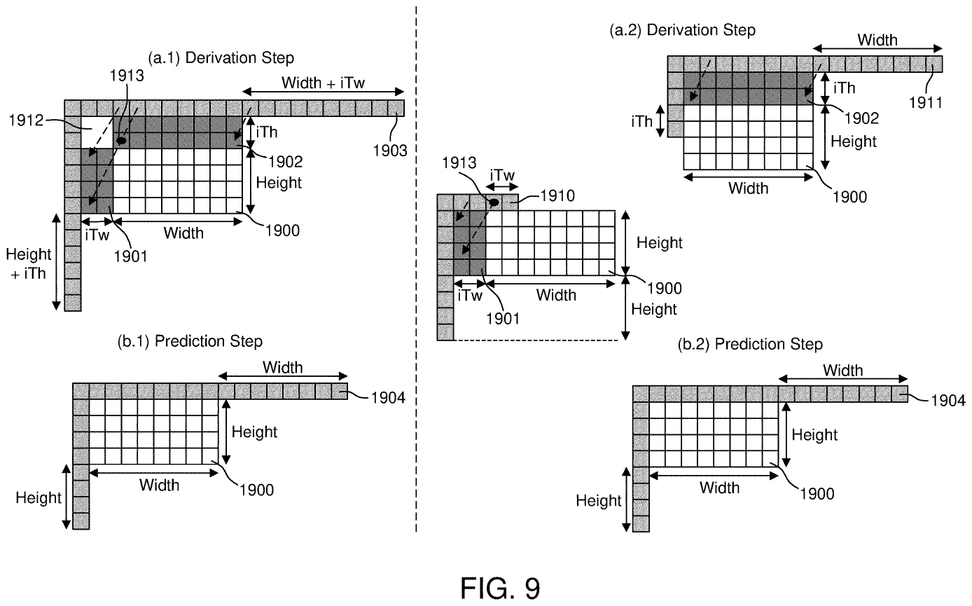

As another example, FIG. 9 copies FIG. 8, except that the intra prediction mode of index 112 replaces that of index 48.

In FIG. 9 (a.2), during the prediction of the left portion (1901) of the template of the block (1900) from the set (1910) of reference samples, the reference sample (1913) is accessed. But, in FIG. 9 (a.1), (1913) is not involved in the prediction of (1901).

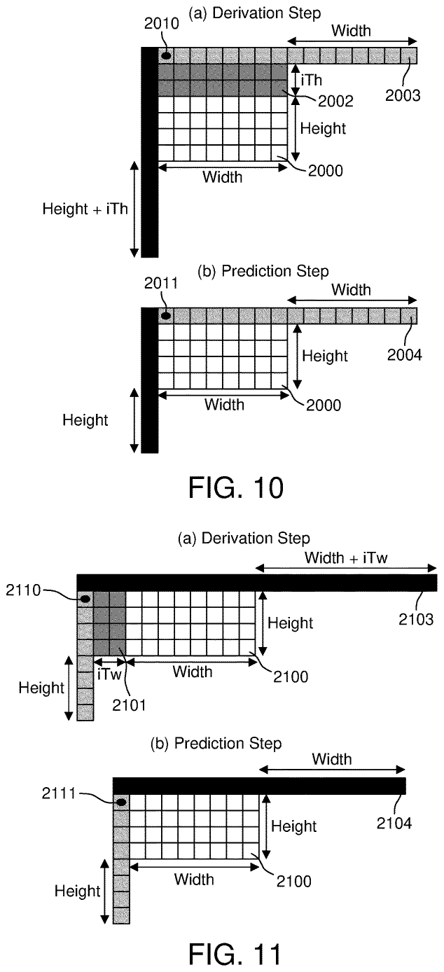

FIG. 10 (a) presents an embodiment wherein only the above portion (2002) of the template of a current block (2000) is available. The set (2003) of reference samples of the template during the derivation step of TIMD is completed with the reference samples colored in black. Since these reference samples are not available, they are generated by padding from the reference sample (2010).

FIG. 11 (a) presents an embodiment wherein only the left portion (2101) of the template of a current block (2100) is available. The set (2103) of reference samples of the template during the derivation step of TIMD is completed with the reference samples colored in black. Since these reference samples are not available, they are generated by padding from the reference sample (2110).

As shown in FIG. 10 (a) and FIG. 11 (a), during the derivation step of TIMD, the design of the reference samples of the template of the current block in ECM and that in the variant embodiment described with these figures correspond to the same design when only one of the two template portions is available.

FIGS. 8 (b.1) and (b.2), FIGS. 9 (b.1) and (b.2), FIG. 10 (b), and FIG. 11 (b) show that, once the derivation step of TIMD has returned the primary and secondary TIMD modes, during the prediction of the current block (1800, 1900, 2000, 2100), the reference samples used for predicting the current block share the same design in ECM and in the embodiment described above.

Note that, for (1803) in FIGS. 8 (a.1), (1810) and (1811) in FIG. 8 (a.2), (1903) in FIGS. 9 (a.1), (1910) and (1911) in FIG. 9 (a.2), (2003) in FIGS. 10, and (2103) in FIG. 11, the shown relationship between the pair {size of the current block, size of its template} and the extension of the set of reference samples of the template towards the right-hand side may be adapted depending on the evolution of TIMD. Similarly, the shown relationship between the pair {size of the current block, size of its template} and the extension of the set of reference samples of the template towards the bottom may also be adapted depending on the evolution of TIMD.

For instance, from ECM-7.0 to ECM-8.0, the set of reference samples of the template has been extended by factor 4 to the right-hand side and bottom due to TIMD testing added wide-angle intra prediction modes from ECM-8.0, as explained above. This extension may straightforwardly apply to this variant embodiment.

In a variant of the embodiment of the TIMD with the adapted sets of reference samples of the template described above in relation with FIG. 8-11, the TIMD follows the same rule defining the wide-angle intra prediction modes as in the TIMD used in ECM. More specifically, in ECM, for a given width×height block using TIMD, during the derivation step of TIMD, for a given intra prediction mode to be tested on the template of this block, the potential conversion of this intra prediction mode into its wide-angle version depends on width and height of the block exclusively. Similarly, in this variant of the embodiment provided herein, in the case of TIMD with the adapted sets of reference samples of the template, for the width×height block using TIMD, during the derivation step of TIMD, the conversion of the intra prediction mode into its wide-angle version follows the same rule based on width and height of the current block.

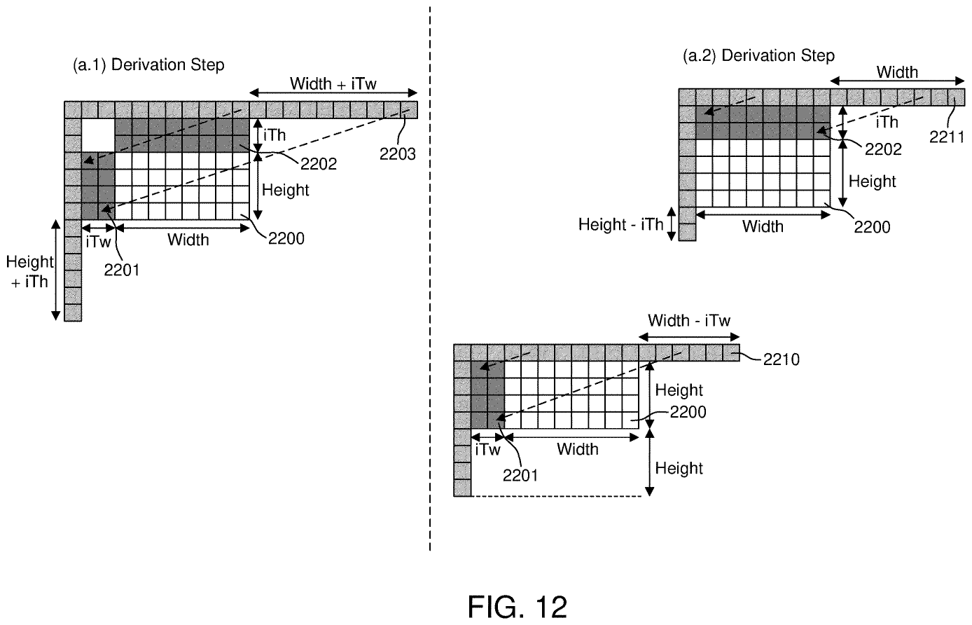

FIG. 12 (a.1) presents an example of TIMD as used in ECM for a given width×height block (2200), during the derivation step of TIMD. In this example, the prediction of the template including its iTw×height left portion 2201) and its width×iTh above portion (2202) from its set (2203) of 2(width+iTw)+2(height+iTh)+1 reference samples of the template is done via the intra prediction mode of index 12. In this example, as width=8 and height=4, before the template prediction, according to the wide-angle conversion rule, the intra prediction mode of index 12 is converted into the wide-angle mode of index 141.

FIG. 12 (a.2) depicts an example of the TIMD as provided herein in an embodiment, for a given width×height block (2200) using TIMD with the adapted sets of reference samples of the template, during the derivation step of TIMD. In this example, the prediction of the iTw×height left template portion (2201) from its set (2210) of reference samples and the prediction of the width×iTh above template portion (2202) from its set (2211) of reference samples is done via the intra prediction mode of index 12. Again, as width=8 and height=4, before the predictions of these two template portions (2201 and 2202), the intra prediction mode of index 12 is converted into the wide-angle mode of index 141. In FIGS. 12 (a.1) and (a.2), the black dotted arrows show the direction of the wide-angle mode of index 141.

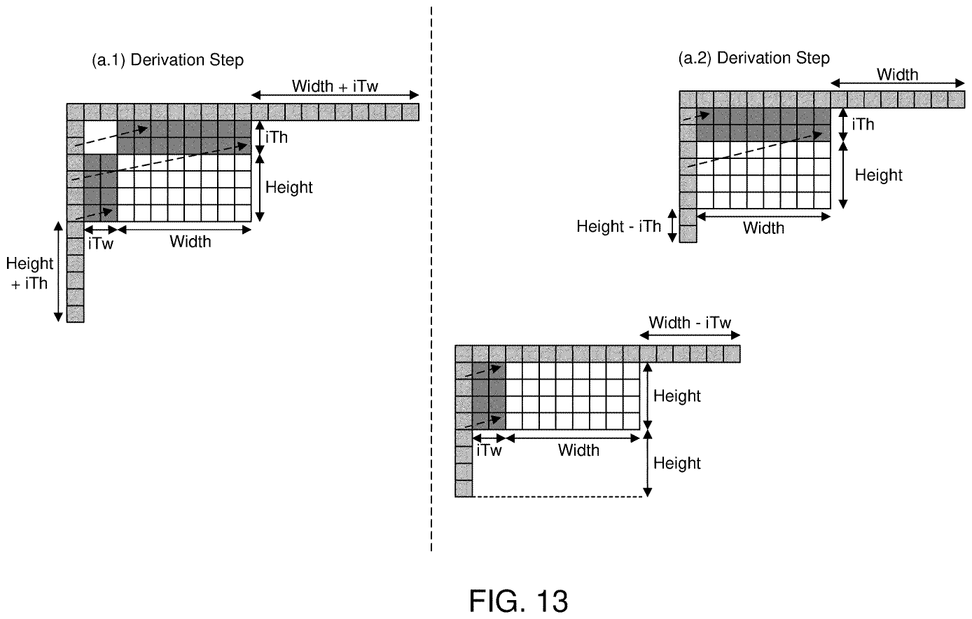

To illustrate with another example, FIG. 13 (a.1) copies FIG. 12 (a.1) and FIG. 13 (a.2) copies FIG. 12 (a.2), except that the intra prediction mode of index 13 replaces that of index 12. In FIGS. 13 (a.1) and (a.2), as width=8 and height=4, the intra prediction mode of index 13 does not undergo any wide-angle conversion.

In a variant of the embodiment above, for a given block using TIMD with the adapted sets of reference samples of the template described herein, during the derivation step of TIMD, each of the two sets of reference samples of template portions is extended to the right-hand side and/or bottom such that the prediction of each of the two template portions is feasible. In other words, the sets of reference samples are extended when needed depending on the intra prediction mode that is tested. If an extended part of the set of reference samples of a template portion includes unavailable pixels, padding as in VVC/ECM is used to fill out the extended part.

For instance, in FIG. 12 (a.2) and FIG. 13 (a.2), the sets of reference samples (2210) includes 2 width reference samples above and on the above-right side of the left portion of the template (2201), making the prediction of the left part of the template (2201) always possible with the embodiment described above. Likewise, the sets of reference samples (2211) comprises 2 height reference samples on the left side and below-left side of the top part of the template (2202), making the prediction of the top part of the template (2202) always manageable with the embodiment described above.

Note that the examples of extensions in FIG. 12 (a.2) and FIG. 13 (a.2) rely on the TIMD template shapes as defined in ECM. This means that,

if width≤8, then iTw=2, otherwise iTw=4,

if height≤8, then iTh=2, otherwise iTh=4.

Other extensions are also possible, for example if the TIMD template shapes are changed to ensure that the prediction of (2201) from (2210) and the prediction of (2202) from (2211) are always feasible for the tested intra prediction modes.

In a variant embodiment, instead of reusing the wide-angle rule as it is used for TIMD in ECM, it is provided herein a variant wherein the wide-angle rule is modified and is based on the size of the portion of the template to be predicted.

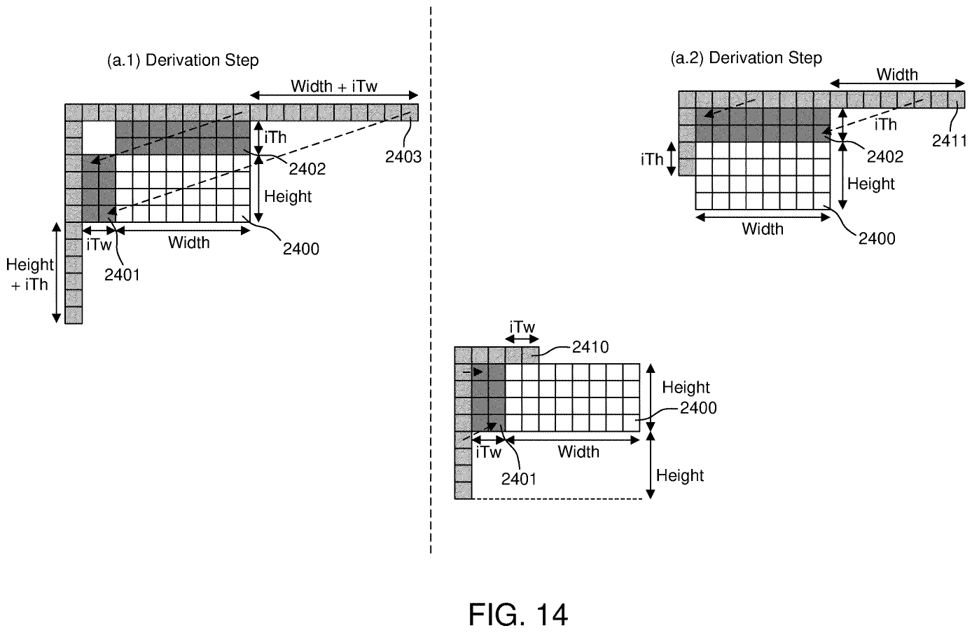

FIG. 14 (a.1) illustrates an example of the derivation step of TIMD as used in ECM, for a given width×height block (2400). In this example, the prediction of the template (2401, 2402) of the block (2400) from the set (2403) of reference samples of the template is done via the intra prediction mode of index 12, as in FIG. 12 (a.1). As width=8 and height=4, before the template prediction, according to the wide-angle conversion rule as define din ECM, the intra prediction mode of index 12 is converted into the wide-angle mode of index 141.

FIG. 14 (a.2) presents an example of the derivation step of TIMD according to an embodiment with the adapted sets of reference samples, for a given width×height block (2400). In this example, the prediction of the iTw×height left template portion (2401) from its set (2410) of reference samples and the prediction of the width×iTh above template portion (2402) from its set (2411) of reference samples is done via the intra prediction mode of index 12.

According to the present embodiment, as iTw=2 and height=4, before the prediction of (2401), no wide-angle conversion applies to the intra prediction mode of index 12. But, as width=8 and iTh=2, before the prediction of (2402), the intra prediction mode of index 12 is converted into the wide-angle mode of index 141. Therefore, in this embodiment, the wide-angle conversion rule is the same as in ECM but the rule is applied based on the size of the template portion that is to be predicted, and not on the size of the block (2400).

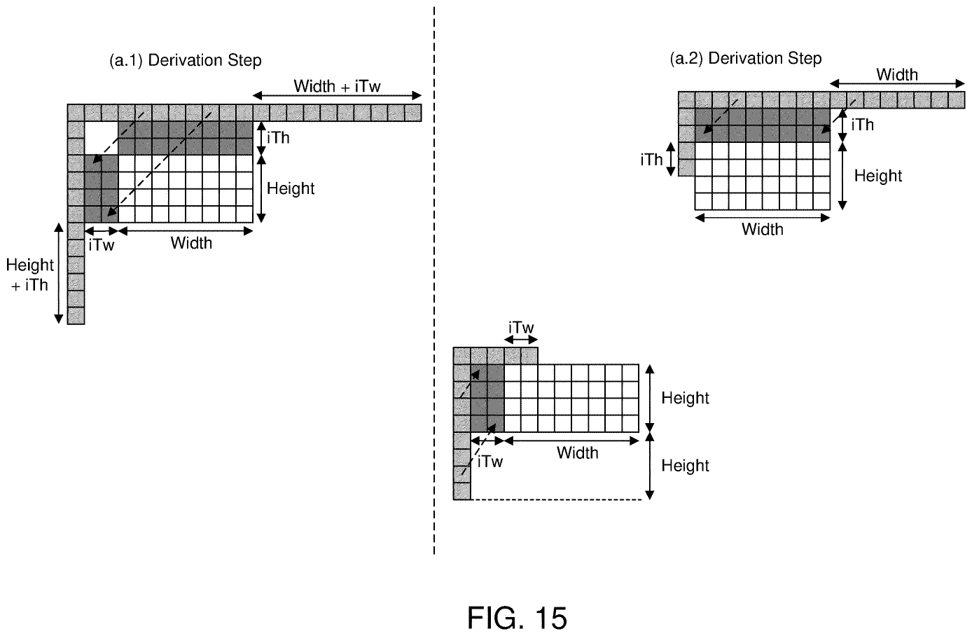

To illustrate with another example, FIG. 15 (a.1) copies FIG. 14 (a.1) and FIG. 15 (a.2) copies FIG. 14 (a.2), wherein the intra prediction mode of index 130 in FIG. 15 replaces that of index 12 used in FIG. 14. In FIG. 15 (a.1), as width=8 and height=4, the intra prediction mode of index 130 does not undergo any wide-angle conversion. In FIG. 15 (a.2), as iTw=2 and height=4, before the prediction of the left portion of the template of the current block, the intra prediction mode of index 130 is converted into the wide-angle mode of index 1. As width=8 and iTh=2, before the prediction of the above portion of the template of the current block, no wide-angle conversion applies to the intra prediction mode of index 130.

Note that, in FIG. 14 (a.2) and FIG. 15 (a.2), for each of the two portions of the template of the block, the shown extension of the set of reference samples of the template portion to the right-hand side and bottom is a simple example working for the prediction via any intra prediction mode within this variant embodiment. This shown extension may be modified without impacting the purpose of the current variant embodiment, i.e. the wide-angle rule based on the size of the template portion to be predicted.

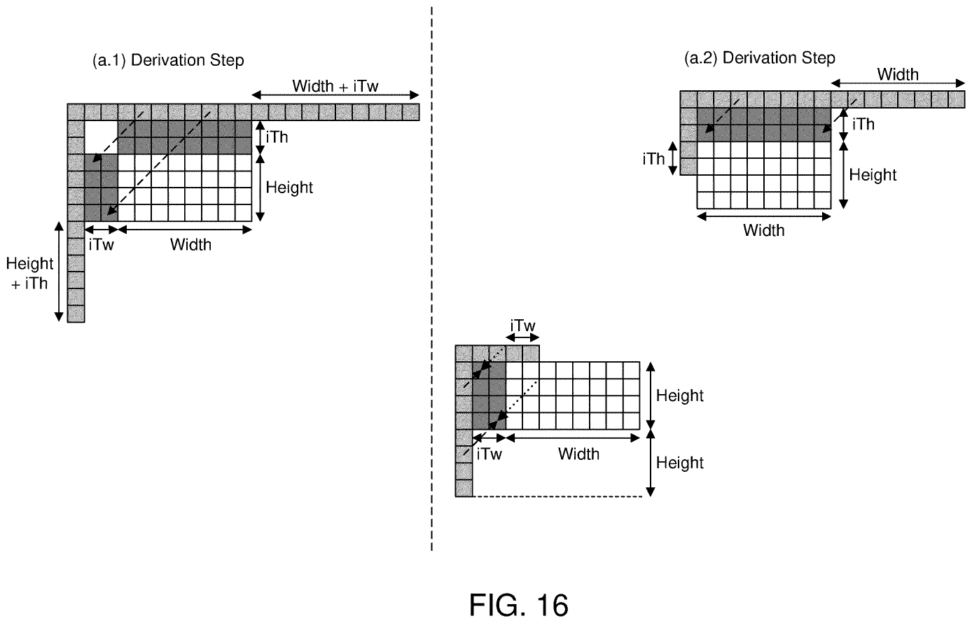

In ECM, the wide-angle rule does not convert a directional intra prediction mode into the intra prediction mode of exact opposite direction. To fix this, in a variant embodiment, the wide-angle rule relies on the size of the portion of the template to be predicted and this wide-angle rule always converts a directional intra prediction mode into the intra prediction mode of exact opposite direction. For instance, this can be done by manipulating the mode indices as follows. In the case of TIMD, i.e. 129 directional intra prediction modes, the index of the directional intra prediction mode of opposite direction with respect to the vertical positive directional intra prediction mode of index iᵥ is iₕ=iᵥ−(EXT_VDIA_IDX−2). Said differently, iₕ−2=iᵥ−EXT_VDIA_IDX, i.e. preservation of the index increment with respect to the “reference” diagonal mode index. The index of the directional intra prediction mode of opposite direction with respect to the horizontal positive directional intra prediction mode of index iₕ is iᵥ=iₕ+(EXT_VDIA_IDX−2). FIG. 16 adapts FIG. 15 to the current variant embodiment. Unlike in FIG. 15 (a.2), in FIG. 16 (a.2), as iTw=2 and height=4, before the prediction of the left portion of the template of the current block, the intra prediction mode of index 130 is converted into the intra prediction mode of index 2. This is because the intra prediction mode of index 130 and that of index 2 have exact opposite directions. In FIG. 16 (a.2), for the prediction of the left portion of the template of the current block, the gray dotted arrow indicates the direction of the intra prediction mode of index 130. The black dotted arrow shows the direction of the intra prediction mode of index 2.

Any of the above embodiments regarding TIMD with the adapted sets of reference samples of the template can be integrated into the process of a TIMD derivation process implemented in a video codec, for instance the ECM.

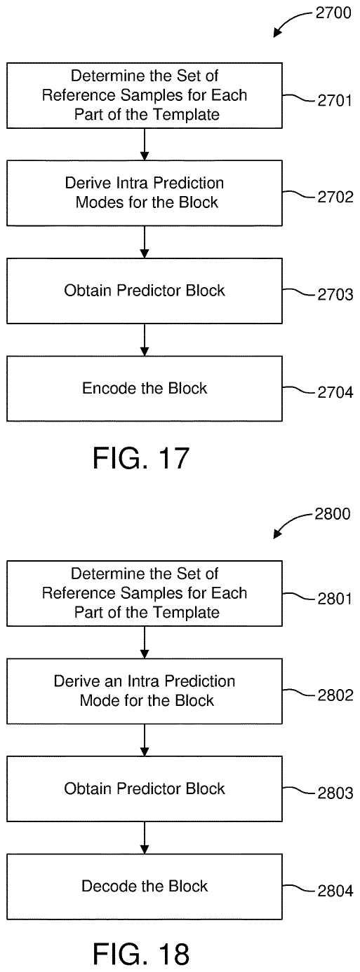

For instance, FIG. 17 illustrates an example of a method 2700 for encoding a video block using TIMD according to any one of the embodiments described herein. At 2701, the sets of reference samples for each part of the template are determined according to any one of the embodiments described herein in relation with FIG. 8-16. More particularly, each part of the template has its own set of reference samples. The sets of reference samples can share some samples in common and have other samples distinct from the other set. However, each set of reference samples is defined based on the part of the template that the set is intended to predict. For that, the set of reference samples defined for a given part of the template is a set of reconstructed samples that are located above and to the left of the given part of the template. In some variant, the reference samples of the set are contiguous to the given part of the template.

Depending on the variants described above that is used, the set of reference samples can be extended on the right-hand side and/or bottom-left of the left or above part of the template, as described in relation with FIG. 12-13.

At 2702, one or more intra prediction modes are derived based on the template of the block using the intra prediction mode derivation process of TIMD with the sets of reference samples for the left and above template portions determined at 2701. Depending on the variants described above that is used, the intra prediction mode that are evaluated in this derivation process can undergo wide-angle conversion if needed, as described in relation with FIG. 12-16.

At 2703, a block predictor for the video block is obtained based on the one or more intra prediction modes that have been derived from the template-based derivation process at 2702. At 2704, the video block is encoded based on the block predictor.

FIG. 18 illustrates an example of a method 2800 for decoding a video block using TIMD according to any one of the embodiments described herein. At 2801, the sets of reference samples for each part of the template are determined according to any one of the embodiments described herein in relation with FIG. 8-16. The same embodiment used at the encoder shall be used on the decoder side. At 2802, one or more intra prediction modes are derived based on the template of the block using the intra prediction mode derivation process of TIMD with the sets of reference samples for the left and above template portions determined at 2801. The derivation process is similar as the one done on the encoder side. At 2803, a block predictor for the video block is obtained based on the one or more intra prediction modes that have been derived from the template-based derivation process at 2802. At 2804, the video block is reconstructed based on the block predictor.

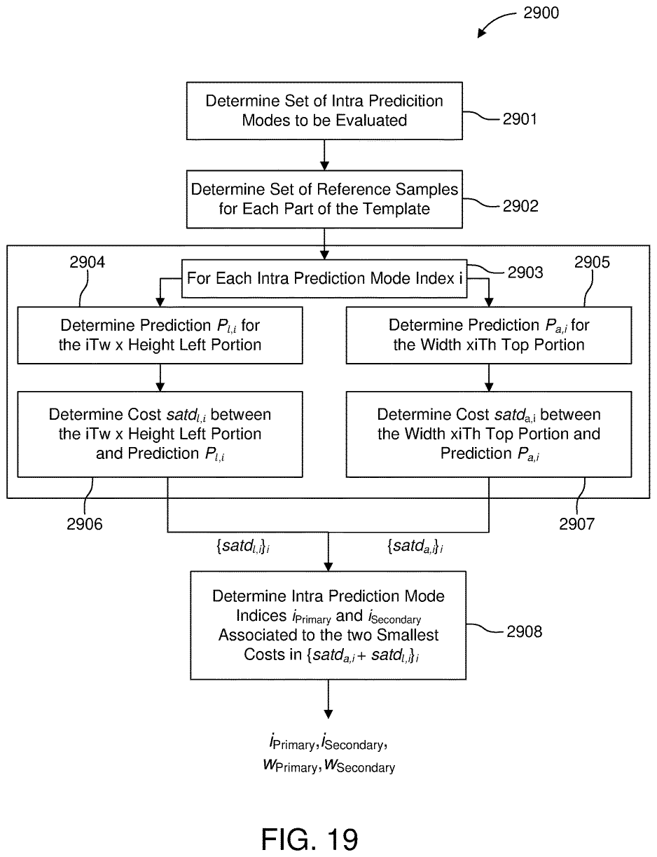

FIG. 19 illustrates an example of a workflow of the derivation (2900) step of TIMD with the adapted sets of reference samples of the template according to the embodiment illustrated in FIG. 8 a.2 or FIG. 9 a.2. The following steps are performed for a current block 1800 to be encoded or decoded.

At 2901, the set of intra prediction modes to be evaluated is determined. For instance, the set of intra prediction modes can be obtained from a list of Most Probable Modes (MPMs) of the current width×height block (1800). This list can be supplemented with intra prediction modes DC_IDX (for DC mode), VER_IDX, and HOR_IDX (vertical and horizontal modes) if these indices do not already appear in the list. At 2902, the set of reference samples for each part of the template (left and top parts) are determined. The left portion (1801) of the template having a size iTw×height uses the set (1810) of reference samples. The top portion (1802) of the template having a size width×iTh uses the set (1811) of reference samples. These sets of reference samples are extracted from the current channel, for instance luminance or chrominance channel.

At 2903, a loop is done on the set of intra prediction modes to be evaluated on the template. For each intra prediction mode index i in the list collected at (2901), the process proceeds to steps (2904 and 2906) for the left portion of template and (2905 and 2907) for the top portion of the template.

At 2904, the prediction P_{l,i} of the left part (1801) of the template is determined from the set of reference samples (1810) via the mode index i. At 2906, the SATD satd_{l,i} between the left part (1801) of the template and the prediction P_{l,i} is calculated.

At 2905, the prediction Pai of top left part (1802) of the template is determined from the set of reference samples (1811) via the mode index i. At 2907, the SATD satd_{a,i} between the top part (1802) of the template and the prediction Pai is calculated.

Once all intra prediction modes of the set have been evaluated, at (2908), one or more intra prediction mode indices are determined based on the costs evaluated in 2906 and 2907. For instance, the two smallest values in the set {satd_{a,i}+satd_{l,i}}ᵢ give the index i_{primary} of the primary TIMD mode and the index i_{secondary} of the secondary TIMD mode.

Besides, two blending weights w_{primary} and w_{secondary} are determined from satdᵢ_{_{primary}} satd_{a,l}_{_{primary}}+satd_{l,i}_{_{primary}} and satdᵢ_{_{secondary}}=satd_{a,i}_{_{secondary}}+satd_{l,i}_{_{secondary}} respectively.

The prediction step of the current block 1800 (step b.2 in FIG. 8) is done using the i_{primary} and i_{secondary} that are used to obtain two predictions of the current block (1800). The predictions for the current block (1800) are obtained using the reference samples (1804) defined for the current block (1800). These two predictions are blended using w_{primary} and w_{secondary}, yielding the final prediction of the current block (1800).

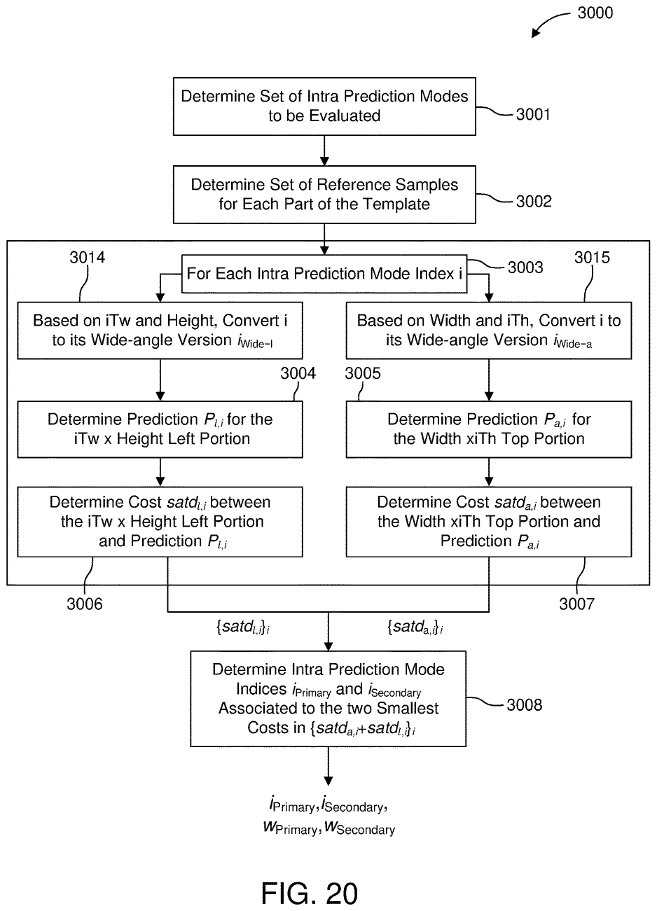

FIG. 20 illustrates another example of a workflow of the derivation (3000) step of TIMD with the adapted sets of reference samples of the template for a variant of the embodiment illustrated in FIG. 14 (a.2). The workflow is not limited to this embodiment, a similar workflow can be applied to the other embodiments illustrated through FIG. 8-16.

At (3001), a set of intra prediction modes to be evaluated by the TIMD is obtained for a current block to predict, the block (2400) having a size of width×height.

For instance, the set of intra prediction modes can be obtained from a list of Most Probable Modes (MPMs) of the current width×height block (2400). This list can be supplemented with intra prediction modes DC_IDX, VER_IDX, and HOR_IDX if these indices do not already appear in it.

At (3002), the set (2410) of reference samples of the iTw×height left portion (2401) of the template of the block (2400) and the set (2411) of reference samples of the width×iTh above portion (2402) of the template of the block (2400) are extracted from the current channel.

At 3003, a loop is done on the set of intra prediction modes to be evaluated on the template. For each intra prediction mode index i in the list collected at (3001), the process proceeds to steps (3014, 3004 and 3006) for the left portion of template and (3015, 3005 and 3007) for the top portion of the template.

At 3014, the parameters for predicting the left part (2401) of the template are derived. Depending on the variants used and the angle of the intra prediction mode, it is determined whether the intra prediction mode index i has to be converted into its associated wide-angle mode index i_{wide-1} depending on iTw and height. If so, the intra prediction mode index i is converted into its associated wide-angle mode index i_{wide-1}.

If the workflow 3000 is implemented using the variant illustrated with FIG. 12-13, at 3014, the conversion is based on the width and height of the current block.

At 3004, the prediction P_{l,i} of (2401) is determined from the set of reference samples (2410) via the mode index i or the mode of index i_{wide-1} if converted at 3014. At 3006, the SATD satd_{l,i} between (2401) and P_{l,i} is calculated.

At 3015, the parameters for predicting the top part of the template (2402) are derived, which comprises if needed the conversion of i into its associated wide-angle mode index i_{wide-a} depending on width and iTh. If the workflow 3000 is implemented using the variant illustrated with FIG. 12-13, at 3015, the conversion is based on the width and height of the current block. At 3005, the prediction P_{a,i} of (2402) is computed from its set of reference samples (2411) via the mode index i or the mode of index i_{wide-a} if converted.

At 3007, the SATD satd_{a,i} between (2402) and P_{a,i} is calculated.

Once all intra prediction modes of the set have been evaluated, at 3008, one or more intra prediction mode indices are determined based on the costs evaluated in 3006 and 3007. For instance, the two smallest values in the set {satd_{a,i}+satd_{l,i}}, give the index i_{primary} of the primary TIMD mode and the index i_{secondary} of the secondary TIMD mode.

Besides, two blending weights w_{primary} and w_{secondary}, are computed from satdᵢ_{_{primary}} satd_{a,i}_{_{primary}}+satd_{l,i}_{_{primary}} and satdᵢ_{_{secondary}}=satd_{a,i}_{_{secondary}}+satd_{l,i}_{_{secondary}} respectively.

During the prediction step of the current block (2400), i_{primary} and i_{secondary} are used to obtain two predictions of the current block (2400). These two predictions are blended using w_{primary} and w_{secondary}, yielding the final prediction of the current block (2400).

In FIG. 19 and FIG. 20, the order of steps inside the workflow 2900 or 3000 of the derivation step of TIMD with the adapted sets of reference samples of the template serves as example only. Some steps can be swapped without affecting the process of the TIMD derivation. For instance, in FIGS. 19 (2901) and (2902) can be swapped.

In ECM, e.g. ECM-8.0, the derivation step of TIMD is part of many template-based coding tools. For instance, the derivation step of TIMD occurs in Intra Block Copy (IBC), Geometric Partition Mode (GPM), and Combined Intra Inter Prediction (CIIP).

In a variant embodiment, the regular derivation step of TIMD in ECM is replaced by the derivation step of TIMD with the adapted sets of reference samples of the template as described in any one of the embodiments provided herein, for one or more of template-based coding tools that involve the derivation step of TIMD.

In another variant embodiment, the regular derivation step of TIMD in ECM is replaced by the derivation step of TIMD with the adapted sets of reference samples of the template as described in any one of the embodiments provided herein, for all the template-based coding tools involving the derivation step of TIMD.

In some embodiments, Position dependent intra prediction combination (PDPC) is included in the derivation of the TIMD modes. Therefore, any one of the embodiments described herein can also be used when applying PDPC in the derivation of the TIMD modes. As explained above, PDPC is a tool that removes the discontinuities arising from the intra prediction at the block boundaries adjacent to the reference samples for some directional intra prediction modes. This is achieved by using a weighted combination of the initial prediction value and one or more secondary reference samples which are located in the reference array of reconstructed reference samples. In the classic TIMD, when PDPC is applied during template prediction, these secondary reference samples are located in the reference samples set defined for the template, that is the array 702 in FIG. 7A (a) for instance. As shown in this figure, the presence of the “hole” between the template parts impacts the efficiency of PDPC.

When TIMD is implemented using any one of the embodiments described herein wherein the set of reference samples is adapted for each part of the template, then the secondary reference samples used in the PDPC tool when predicting the template are located in the set of reference samples defined for each part of the template, for example as illustrated on FIG. 9 a.2. Thus, in these embodiments, PDPC efficiency is improved.

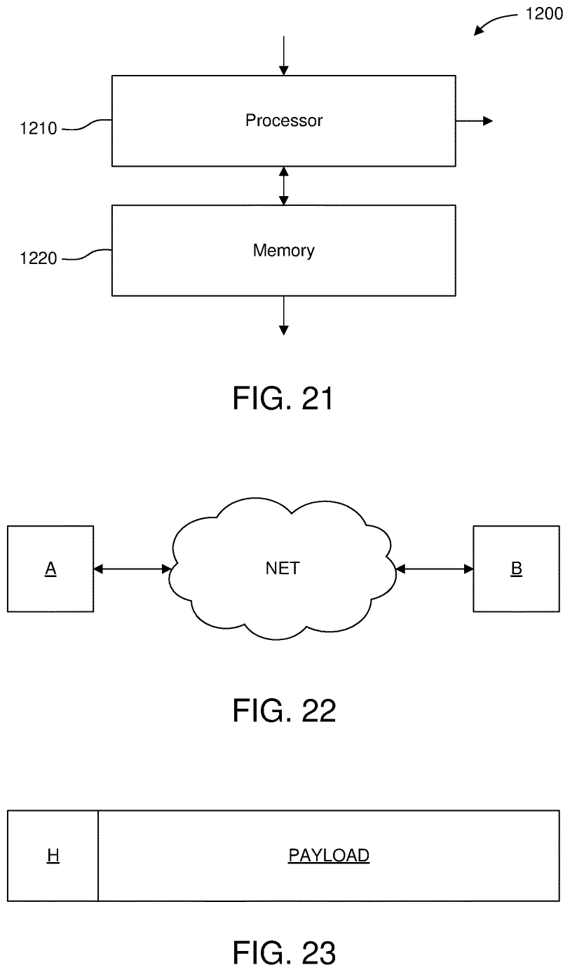

FIG. 21 illustrates a block diagram of a system within which aspects of the present embodiments may be implemented, according to another embodiment. FIG. 21 shows one embodiment of an apparatus 1200 for encoding or decoding a video according to any one of the embodiments described herein. The apparatus comprises Processor 1210 and can be interconnected to a memory 1220 through at least one port. Both Processor 1210 and memory 1220 can also have one or more additional interconnections to external connections.

Processor 1220 is also configured to obtain a predictor block for a video block based on an angular intra prediction mode that uses at least one primary reference sample, modify the predictor block using a position dependent pixel combination that uses for at least one pixel, a weighted combination of values determined from at least two secondary reference samples, and encode or decode the video block based at least on the modified predictor block, using any one of the embodiments described herein. For instance, the processor 1220 is configured using a computer program product comprising code instructions that implements any one of embodiments described herein.

In an embodiment, illustrated in FIG. 22, in a transmission context between two remote devices A and B over a communication network NET, the device A comprises a processor in relation with memory RAM and ROM which are configured to implement a method for encoding a video, as described with FIG. 1-20 and the device B comprises a processor in relation with memory RAM and ROM which are configured to implement a method for decoding a video as described in relation with FIG. 1-20. In accordance with an example, the network is a broadcast network, adapted to broadcast/transmit a coded video from device A to decoding devices including the device B.

FIG. 23 shows an example of the syntax of a signal transmitted over a packet-based transmission protocol. Each transmitted packet P comprises a header H and a payload PAYLOAD. In some embodiments, the payload PAYLOAD may comprise video data according to any one of the embodiments described above.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, entropy decoding a sequence of binary symbols to reconstruct image or video data.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method, comprising:
obtaining at least one derived intra prediction mode for a video block using a template-based intra prediction mode derivation,
wherein the template-based intra prediction mode derivation comprises predicting a template of the video block based on a first intra prediction mode that uses reference samples of the template,
wherein the template of the video block comprises a top part located above the video block and a left part located on the left of the video block, and
wherein predicting the top part of the template based on the first intra prediction mode uses a first set of reference samples and predicting the left part of the template based on the first intra prediction mode uses a second set of reference samples, the first set of reference samples and the second set of reference samples being different, and
wherein at least one of the first set of reference samples includes one or more reconstructed samples of the left part of the template or the second set of reference samples includes one or more reconstructed samples of the top part of the template,
obtaining a block predictor for the video block based on the at least one derived intra prediction mode, and
decoding the video block based on the block predictor.

2. An apparatus, comprising one or more processors, wherein the one or more processors are operable to
obtain at least one derived intra prediction mode for a video block using a template-based intra prediction mode derivation,
wherein the template-based intra prediction mode derivation comprises predicting a template of the video block based on a first intra prediction mode that uses reference samples of the template,
wherein the template of the video block comprises a top part located above the video block and a left part located on the left of the video block,
wherein predicting the top part of the template based on the first intra prediction mode uses a first set of reference samples and predicting the left part of the template based on the first intra prediction mode uses a second set of reference samples, the first set of reference samples and the second set of reference samples being different, and
wherein at least one of the first set of reference samples includes one or more reconstructed samples of the left part of the template or the second set of reference samples includes one or more reconstructed samples of the top part of the template,
obtain a block predictor for the video block based on the at least one derived intra prediction mode, and
decode the video block based on the block predictor.

3. A method, comprising:
obtaining at least one derived intra prediction mode for a video block using a template-based intra prediction mode derivation,
wherein the template-based intra prediction mode derivation comprises predicting a template of the video block based on a first intra prediction mode that uses reference samples of the template,
wherein the template of the video block comprises a top part located above the video block and a left part located on the left of the video block,
wherein predicting the top part of the template based on the first intra prediction mode uses a first set of reference samples and predicting the left part of the template based on the first intra prediction mode uses a second set of reference samples, the first set of reference samples and the second set of reference samples being different, and
wherein at least one of the first set of reference samples includes one or more reconstructed samples of the left part of the template or the second set of reference samples includes one or more reconstructed samples of the top part of the template,
obtaining a block predictor for the video block based on the at least one derived intra prediction mode, and
encoding the video block based on the block predictor.

4. An apparatus, comprising one or more processors, wherein the one or more processors are operable to
obtain at least one derived intra prediction mode for a video block using a template-based intra prediction mode derivation,
wherein the template-based intra prediction mode derivation comprises predicting a template of the video block based on a first intra prediction mode that uses reference samples of the template,
wherein the template of the video block comprises a top part located above the video block and a left part located on the left of the video block,
wherein predicting the top part of the template based on the first intra prediction mode uses a first set of reference samples and predicting the left part of the template based on the first intra prediction mode uses a second set of reference samples, the first set of reference samples and the second set of reference samples being different, and
wherein at least one of the first set of reference samples includes one or more reconstructed samples of the left part of the template or the second set of reference samples includes one or more reconstructed samples of the top part of the template,
obtain a block predictor for the video block based on the at least one derived intra prediction mode, and
encode the video block based on the block predictor.

5. (canceled)

6. The method of claim 1, wherein the first set of reference samples includes one or more reconstructed samples located on a row just above the top part of the template and on a column just on the left of the top part of the template and/or the second set of reference samples includes one or more reconstructed samples located on a row just above the left part of the template and on a column just on the left of the left part of the template.

7. The method of claim 1, wherein for predicting the template, at least one of the first set or the second set is extended to the top-right of the top part or left part of the template or to the bottom-left of the top or left part of the template or both to the top-right and to the bottom-left, depending on the first intra prediction mode.

8. The method of claim 1, wherein the first intra prediction being a directional intra prediction mode, predicting the template comprises determining whether a wide-angle conversion is to be applied to the first intra prediction mode before predicting one of the top part of or the left part based on a size of the one of the top part or the left part of the template.

9. The method of claim 8, wherein responsive to the determination that a wide-angle conversion is to be applied to the first intra prediction mode, converting the first intra prediction mode into a second intra prediction mode based on the size of the one of the top part or the left part of the template and determining a prediction for the one of the top part or the left part of the template based on the second intra prediction mode.

10. The method of claim 9, wherein the second intra prediction mode is an intra prediction mode in an opposite direction of the first intra prediction mode.

11. (canceled)

12. A non-transitory computer readable medium storing executable program instructions to cause a computer executing the program instructions to perform a method according to claim 1.

13-14. (canceled)

15. A device comprising:
an apparatus according to claim 2; and
at least one of (i) an antenna configured to receive or transmit a signal, the signal including data representative of the video block, (ii) a band limiter configured to limit the signal to a band of frequencies that includes the data representative of the video block, or (iii) a display configured to display the video block.

16. A device according to claim 15, wherein the device comprises at least one of a television, a cell phone, a tablet, a set-top box.

17. The method of claim 3, wherein the first intra prediction being a directional intra prediction mode, predicting the template comprises determining whether a wide-angle conversion is to be applied to the first intra prediction mode before predicting one of the top part or the left part based on a size of the one of the top part or the left part of the template.

18. The method of claim 17, wherein responsive to the determination that a wide-angle conversion is to be applied to the first intra prediction mode, converting the first intra prediction mode into a second intra prediction mode based on the size of the one of the top part or the left part of the template and determining a prediction for the one of the top part or the left part of the template based on the second intra prediction mode.

19. The method of claim 18, wherein the second intra prediction mode is an intra prediction mode in an opposite direction of the first intra prediction mode.

20. The apparatus of claim 2, wherein the first intra prediction being a directional intra prediction mode, predicting the template comprises determining whether a wide-angle conversion is to be applied to the first intra prediction mode before predicting one of the top part or the left part based on a size of the one of the top part or the left part of the template.

21. The apparatus of claim 20, wherein responsive to the determination that a wide-angle conversion is to be applied to the first intra prediction mode, converting the first intra prediction mode into a second intra prediction mode based on the size of the one of the top part or the left part of the template and determining a prediction for the one of the top part or the left part of the template based on the second intra prediction mode.

22. The apparatus of claim 4, wherein the first intra prediction being a directional intra prediction mode, predicting the template comprises determining whether a wide-angle conversion is to be applied to the first intra prediction mode before predicting one of the top part or the left part based on a size of the one of the top part or the left part of the template.

23. The apparatus of claim 22, wherein responsive to the determination that a wide-angle conversion is to be applied to the first intra prediction mode, converting the first intra prediction mode into a second intra prediction mode based on the size of the one of the top part or the left part of the template and determining a prediction for the one of the top part or the left part of the template based on the second intra prediction mode.

24. The apparatus of claim 23, wherein the second intra prediction mode is an intra prediction mode in an opposite direction of the first intra prediction mode.
